(19) United States
(12) Patent Application Publication
(10) Pub. No.: US 2023/0414328 A1
(43) Pub. Date: Dec. 28, 2023

(54) TEMPOROMANDIBULAR JOINT DISORDER TREATMENT METHODS AND SYSTEMS

(71) Applicant: Charles Sutera, III, Medford, MA (US)

(72) Inventor: Charles Sutera, III, Medford, MA (US)

(21) Appl. No.: 18/339,770

(22) Filed: Jun. 22, 2023

Related U.S. Application Data
(60) Provisional application No. 63/354,472, filed on Jun. 22, 2022.

(51) Int. Cl. A61C 7/36; A61C 7/00

(52) U.S. Cl. CPC A61C 7/36; A61C 9/0053; A61C 7/002

(57) ABSTRACT

Implementations herein include orthodontic treatment methods, systems and devices. Such implementations may include receiving a bite registration of the patient taken after the patient has worn a first mandibular positioning device configured to stabilize the symptom. Further, a design parameter of an orthodontic aligner series comprising one or more orthodontic aligners, each comprising a polymeric shell, may be generated. The design parameter may be configured to configure each orthodontic aligner to impart a force to one or more of the patient's teeth such that the the imparted force causes the one or more of the patient's teeth to tend to move toward equilibration of an occlusal surface of each of the one or more of the patient's teeth.

### CROSS REFERENCE TO RELATED APPLICATIONS

This application claims priority to U.S. Provisional Application No. 63/354,472, filed on 22 Jun. 2022, the entire disclosure of which is hereby incorporated by reference.

### BACKGROUND

The position of the mandible is important. When the position of the mandible deviates from an acceptable position to another position, symptoms such as those of temporomandibular joint disorder develop. Temporomandibular joint disorder is a condition which causes a multitude of symptoms of the head and neck included but not limited to muscle tension, headaches, and bruxism. The mandibular position at which the temporomandibular complex routinely functions is a primary etiology of said symptoms. One primary factor that affects the mandibular position is the relationship between the mandibular and maxillary teeth when the mandible closes into centric occlusion.

### BRIEF DESCRIPTION OF THE FIGURES

For a fuller understanding of the nature and objects of the disclosure, reference should be made to the following detailed description taken in conjunction with the accompanying drawings, in which:

FIG. 1 illustrates an oblique view of a device comprising one or more mandibular position adjustment appliances having a polymeric shell with cavities shaped to receive teeth, according to one or more implementations;

FIG. 2 illustrates a frontal view of a device and the mandible in an open position, while attaching to an arch of teeth and occlusal surface, according to one or more implementations;

FIG. 3 illustrates a frontal view of a device and the mandible in a closed position demonstrating an occlusal surface which does not contact the non-supporting cusps of the opposing arch, and a reduction of occlusal interferences from lateral excursive movement and/or protrusive movement, according to one or more implementations;

FIG. 4 illustrates a frontal view of a device and the mandible in a closed position demonstrating a preferred embodiment comprising an occlusal surface which may be manually modified by removing or reshaping at least some portion of the surface, according to one or more implementations;

FIG. 5 illustrates a frontal view of a device and the mandible occluding on a device while obtaining a bite registration by use of an intraoral scanner, according to one or more implementations;

FIG. 6 illustrates a frontal view of a device and the mandible occluding on a device while obtaining a bite registration by use of bite registration material, according to one or more implementations;

FIG. 7 illustrates a frontal view of one or more teeth position adjustment appliances having a polymeric shell with cavities shaped to receive teeth, according to one or more implementations;

FIG. 8 illustrates a frontal view of one or more plurality of teeth position adjustment appliances having a polymeric shell with cavities shaped to receive teeth and a means for movement of at least one tooth, according to one or more implementations;

FIG. 9 illustrates an operational environment, according to one or more implementations;

FIG. 10 illustrates a diagram of example components of one or more devices of FIG. 9, according to one or more implementations; and

FIG. 11 is a flowchart illustrating an example method 1100 for orthodontic treatment, according to one or more implementations.

### DETAILED DESCRIPTION

It is to be understood that the invention is not limited in its application to the details of construction and the arrangements of components and/or method steps set forth in the following description or illustrated in the drawings, and phraseology and terminology used herein is for the purpose of description and should not be regarded as limiting. The invention is capable of other embodiments and of being practiced or being carried out in various ways. Accordingly, other aspects, advantages, and modifications will be apparent to those skilled in the art to which the invention pertains, and these aspects and modifications are within the scope of the invention, which is limited only by the appended claims.

Conventional oral splint therapy has been attempted to treat symptoms of temporomandibular joint disorder. Conventional systems may employ splints to reposition the mandible to a new position, which may be evaluated to confirm reduction of symptoms. However, when a new position with reduced symptoms is established, conventional methods lack means for transferring the data from the splint position to optimize the patient's mandibular position permanently so that a splint may no longer be required.

Implementations herein include improved systems, methods, and devices for treating temporomandibular joint disorder (TMJ) and associated symptoms. Systems may include one or more oral appliances, which may be produced in sequence via data from at least one bite registration. An oral appliance may securely attach to one or more teeth and include an occluding surface which contacts an opposing arch of the teeth. Implementations may equilibrate the occlusal contacts or reduce protrusive interferences and/or lateral excursive interferences of the occlusion. As a patient wears the appliance produced in accordance with implementations herein, the mandible may reposition into a more comfortable position. The mandibular position measured by occlusion at which the appliance occludes may be recorded via a digital or physical bite registration, and said mandibular position may be utilized to aid orthodontic treatment, including to orthodontically adjust the position of the mandible to an optimized position.

Implementations may thus provide improvements over conventional methods for treatment of TMJ disorder and associated symptoms.

Implementations may employ computer-aided methods of design and manufacturing, an improved method for adjusting the mandibular position via repositioning device, and utilizing the mandibular repositioning device to determine an appropriate mandibular position for orthodontic treatment.

In some implementations, a method may include repositioning the mandible into a position that reduces headaches and tension of the muscles of the head and neck by comprising a disocclusion device, taking a recording of the mandibular position while wearing said disocclusion device or at least some portion of said device, and choosing at least one tooth and at least moving it by translation and/or rotation by one or more sequential polymeric shells with cavities shaped to receive teeth that exert force on the teeth to cause said movement.

In some implementations, a system may include one or more mandibular position adjustment appliances having a polymeric shell with cavities shaped to receive teeth, an occlusal surface which when worn by a patient has means to equilibrate distribution of bite force and a means to at least reduce lateral excursive and/or protrusive interferences of occlusion, a means of taking a bite registration (e.g., using a scanner or a bite registration material, etc.) using at least a portion of said mandibular position adjustment appliance, and a means of moving at least one tooth by one or more sequential polymeric shells with cavities shaped to receive teeth that exert force on the teeth to cause said movement.

In some implementations, a method may include designing a device that reduces headaches and tension of the muscles of the head and neck by utilizing a computer-aided design algorithm. In such a computer-aided design algorithm a mandibular positioning device may be optimized to equilibrate the occlusal surface in a disoccluded centric occlusion. A patient may wear the device to confirm optimization of symptoms. A digital or physical bite registration may be taken using at least a portion of said mandibular positioning device, and at least one tooth is rotated or translated by one or more sequential polymeric shells having one or more cavities shaped to receive teeth that exert force on the teeth to cause said movement.

In some implementations, a system for repositioning a teeth and/or mandibular position from an initial location to a desired location may include a first polymeric shell having an occlusal surface and plurality of cavities shaped to receive a tooth arch of the user. The occlusal surface may be configured and optimized to at least improve equilibration of the mandibular position when worn for a period of time. A bite registration of the patient may be taken while wearing said first polymeric shell orthotic or at least some portion of it. A plurality of dental position adjustment appliances having a polymeric shell with cavities shaped to receive and resiliently reposition teeth may be designed. These may include, for example, at least one appliance which is shaped to rotate a preselected tooth so that a crown of the tooth leans away from a desired location and at least another appliance shaped to apply a force to the at least one tooth and/or to translate the at least one tooth toward the desired location such that the resulting mandibular position after optimized tooth movement is at least somewhat more comfortable than the mandibular position when the teeth were in the original occlusion.

In some implementations, a computer-implemented method for repositioning the teeth and/or mandible of a user. Such a method may include, for example, executing on a processor steps of: receiving, on a computer, a digital bite registration data indicating at least the mandibular and maxillary position of a user when wearing a polymeric shell having an occlusal surface that said occlusal surface confirms at least one optimization function such as mandibular force equilibration; storing the digital bite registration data in the memory of the computer; using the stored digital bite registration data to generate a digital arrangement of the user's teeth; applying an optimization function to the digital arrangement of the user's teeth by specifying a sequence of tooth movements to move the teeth through a series of discrete tooth arrangements, wherein at least some of the tooth arrangements are represented by digital data sets, wherein specifying a sequence of tooth movements comprises moving teeth according to an optimization function; and transmitting the optimized production data set for fabrication of one or more appliances in accordance with the digital data sets wherein the appliances comprise polymeric shells having cavities and wherein the cavities of successive shells have different geometries shaped to receive and resiliently reposition teeth from one tooth arrangement to a successive tooth arrangement.

In some implementations, an apparatus for producing appliances to treat symptoms of temporomandibular joint disorder may include a means for generating a digital arrangement of teeth (e.g., a bite registration device, a scanning device, an imaging device, etc.); specifying a bite registration in a disoccluded occlusion to determine an optimization function; generating at least one mandibular repositioning appliances in accordance with the specified bite registrations, confirming a desired optimization function when said mandibular repositioning appliance is worn by a user, specifying a digital or physical bite registration taken when a user is wearing at least a portion of said mandibular positioning appliance, and moving at least one tooth utilizing a series of a polymeric shells with cavities shaped to receive teeth capable of exerting force on at least one tooth to achieve an optimized movement such that the mandible is capable of being repositioned according to said optimization function reference.

In some implementations, a system for repositioning teeth and/or mandibular position from an initial location to a desired location may include a first polymeric shell having an occlusal surface and plurality of cavities shaped to receive a tooth arch of the user; wherein the occlusal surface is configured to at least improve equilibration of the mandibular position when worn for a period of time; taking a bite registration while wearing said first polymeric shell orthotic or at least some portion of it; a plurality of dental position adjustment appliances having a polymeric shell with cavities shaped to receive and resiliently reposition teeth, including at least one appliance which is shaped to rotate a preselected tooth so that a crown of the tooth leans away from a desired location and at least another appliance shaped to apply a force to the at least one tooth to translate the at least one tooth toward the desired location; and one or more attachment devices able to be positioned on teeth for use in transmitting forces from the positioning adjustment appliances to the teeth.

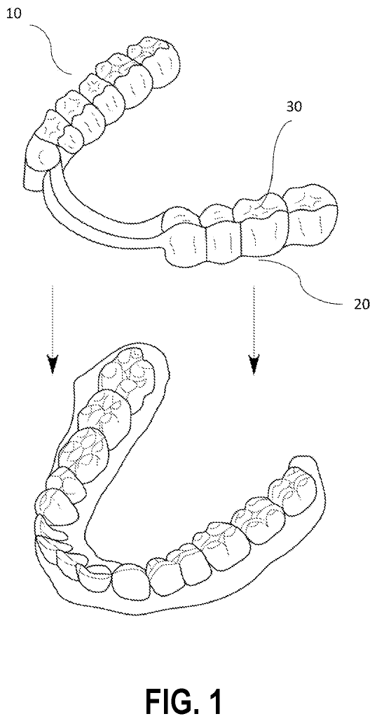

FIG. 1 illustrates an oblique view of a device comprising one or more mandibular position adjustment appliances having a polymeric shell with cavities shaped to receive teeth, according to one or more implementations.

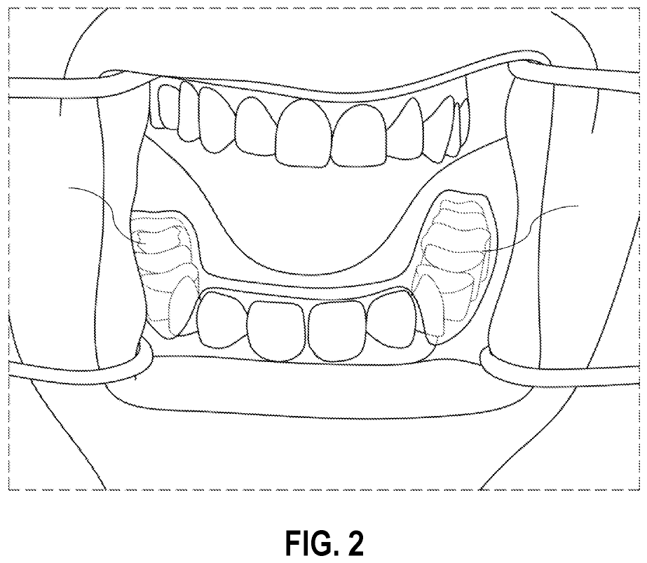

FIG. 2 illustrates a frontal view of a device and the mandible in an open position, while attaching to an arch of teeth and occlusal surface, according to one or more implementations.

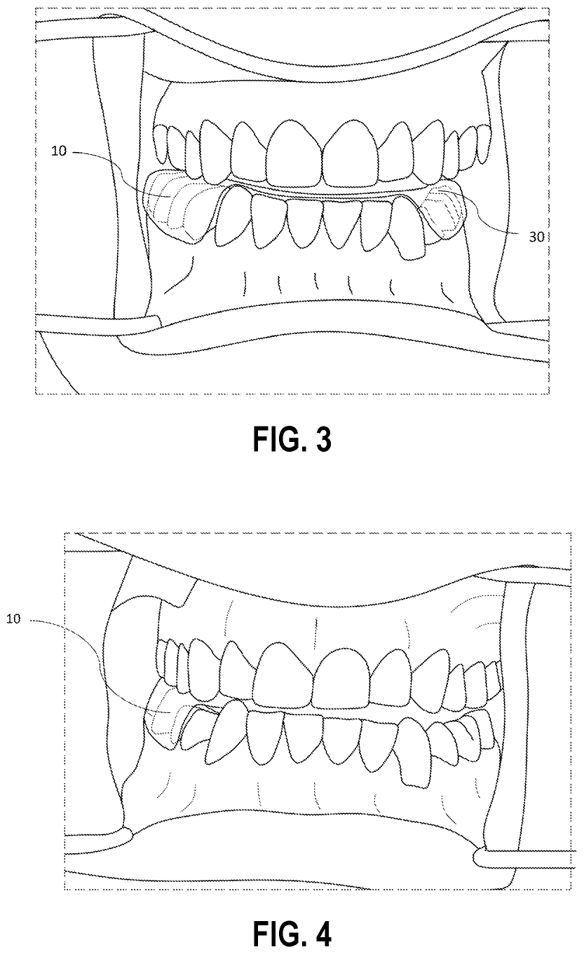

FIG. 3 illustrates a frontal view of a device and the mandible in a closed position demonstrating an occlusal surface which does not contact the non-supporting cusps of the opposing arch, and a reduction of occlusal interferences from lateral excursive movement and/or protrusive movement, according to one or more implementations.

FIG. 4 illustrates a frontal view of a device and the mandible in a closed position demonstrating a preferred embodiment comprising an occlusal surface which may be manually modified by removing or reshaping at least some portion of the surface, according to one or more implementations.

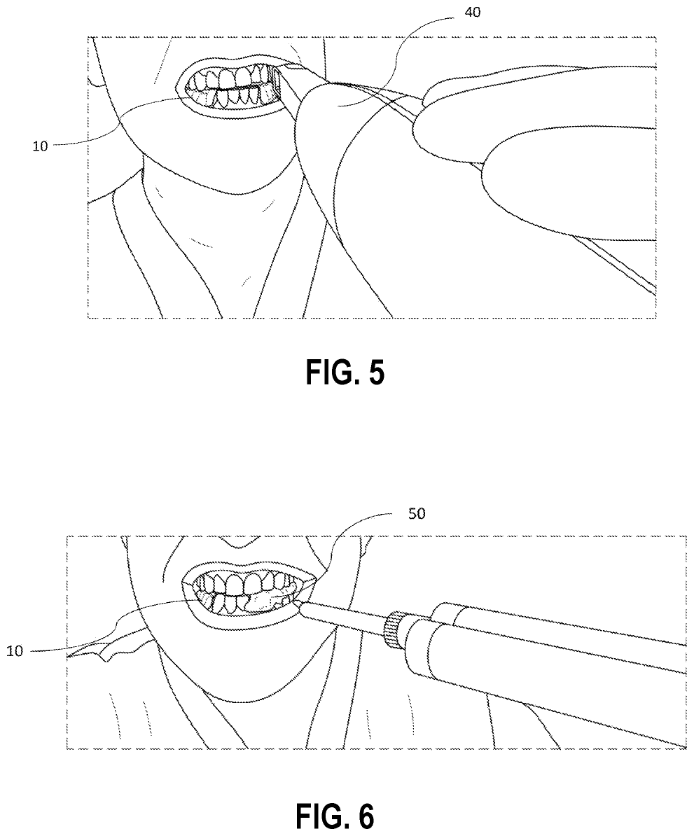

FIG. 5 illustrates a frontal view of a device and the mandible occluding on a device while obtaining a bite registration by use of an intraoral scanner, according to one or more implementations.

FIG. 6 illustrates a frontal view of a device and the mandible occluding on a device while obtaining a bite registration by use of bite registration material, according to one or more implementations.

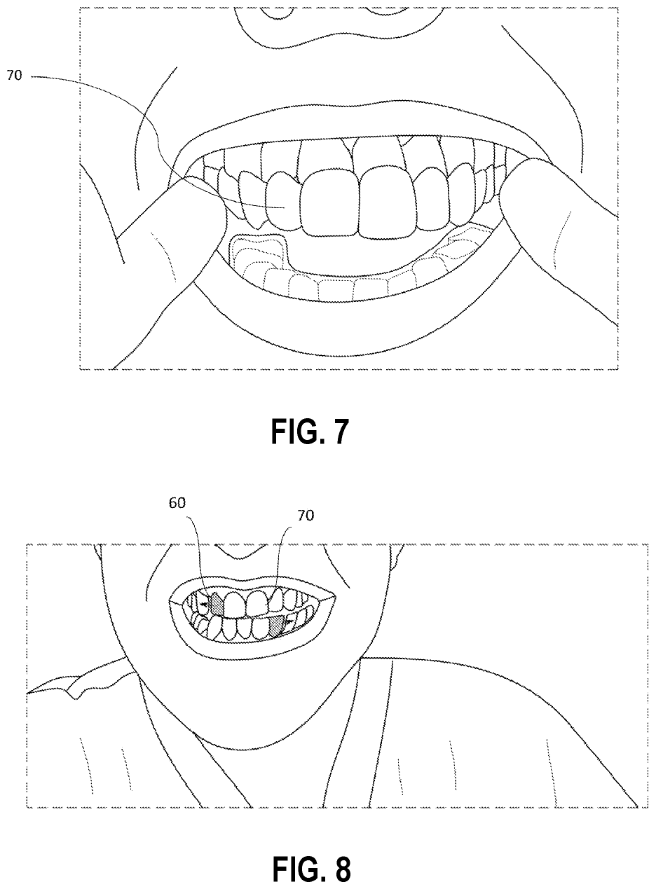

FIG. 7 illustrates a frontal view of one or more teeth position adjustment appliances having a polymeric shell with cavities shaped to receive teeth, according to one or more implementations.

FIG. 8 illustrates a frontal view of one or more plurality of teeth position adjustment appliances having a polymeric shell with cavities shaped to receive teeth and a means for movement of at least one tooth, according to one or more implementations.

With reference to FIGS. 1-8, The preferred embodiment may include attachment of one or more disocclusion devices to a plurality of teeth 10. The disocclusion device(s) may contain a polymeric shell with cavities shaped to receive teeth 20 and may be inserted by hand. Each device may have an occlusal surface 30, which contacts the opposing arch so that the occlusal surface at least disoccludes the mandible. The device may be worn for at least some period of time during which a patient's symptoms are monitored and adjustments may be made to the said device during said time until a desired optimization function is achieved. In one embodiment, said adjustments may be equilibration of the occlusal surface 30 of said device and said optimization function is an improvement of at least one symptom.

After said time, a position record of the mandible may be taken. In one embodiment, said position record may be recorded by taking a bite registration with a digital intraoral scanner 40 while a user wears at least a portion of said disocclusion device 10. In an additional embodiment, said position record may be recorded by taking a bite registration using bite registration material 50 while a user wears at least a portion of said disocclusion device 10.

In an additional embodiment, said position record may be recorded by scanning the patient with a cone beam CT or similar imaging technology while a user occludes on at least a portion of said disocclusion device 10. The position record may at least be used as a reference for at least one optimization function of an orthodontic treatment plan. In one embodiment said position record may be utilized to select at least one tooth and at least moving it by translation and/or rotation 60 by one or more sequential polymeric shells 70 with cavities shaped to receive teeth that exert force on the teeth to cause said movement utilizing said position record as an optimization function reference. In one embodiment said sequential polymeric shells 70 are composed of a clear resin material.

Implementations of a system may include a single or a plurality of mandibular position adjustment appliances 10 having a polymeric shell with cavities shaped to receive teeth, a means of taking a mandibular position registration using at least a portion of said mandibular position adjustment appliance, and moving at least one tooth by one or more sequential polymeric shells 70 with cavities shaped to receive teeth that exert force on the teeth to cause said movement.

In one embodiment, said mandibular position adjustment appliances may have an occlusal surface 30, which, when worn by a patient, may equilibrate distribution of bite force and a means to at least reduce lateral excursive and/or protrusive interferences of occlusion.

In another embodiment, said position record may be recorded by taking a bite registration with a digital intraoral scanner 40 while a user wears at least a portion of said device 10. In an additional embodiment, said position record may be recorded by taking a bite registration using bite registration material 50 while a user wears at least a portion of said device. In an additional embodiment, said position record may be recorded by scanning the patient with a cone beam CT or similar imaging technology while a user occludes on at least a portion of said device. In an additional embodiment, said position record may at least be used as a reference for at least one optimization function of an orthodontic treatment plan.

In one embodiment said position record may be utilized to select at least one tooth and move it by translation and/or rotation by one or more sequential polymeric shells with cavities shaped to receive teeth that exert force on the teeth to cause said movement 60 utilizing said position record as an optimization function reference. In one embodiment, said sequential polymeric shells 70 may be composed of a clear resin material.

Implementations may include a method including designing a device 10 that reduces headaches and tension of the muscles of the head and neck by utilizing a computer aided design algorithm. In said computer aided design algorithm, a mandibular positioning device 10 is designed by equilibrating the occlusal surface 30 in a disoccluded centric occlusion. A patient may wear said device to confirm optimization of symptoms. An occlusal positional record may be taken using at least a portion of said mandibular positioning device 10. At least one tooth may be rotated or translated 60 by one or more sequential polymeric shells 70 with cavities shaped to receive teeth that exert force on the teeth to cause said movement.

In one embodiment, said disoccluded centric occlusion may be recorded by placing a bite stop on the anterior teeth and having the user attempt to close into centric occlusion until they feel contact on the anterior stop. In another embodiment, said optimization symptoms may include improvement of at least one symptom of the head and neck. In another embodiment, said occlusal positional record may be utilized to at least aid in some reference in determining an orthodontic treatment plan. In one embodiment, said sequential polymeric shells 70 may be composed of a clear resin material.

In some implementations, a system may provide for repositioning a teeth and/or mandibular position from an initial location to a desired location, said system comprising a first polymeric shell 10 having an occlusal surface and plurality of cavities shaped to receive a tooth arch of the user. The occlusal surface 30 may be configured to at least improve equilibration of the mandibular position when worn for a period of time; taking a bite registration while wearing said first polymeric shell orthotic or at least some portion of it, a plurality of dental position adjustment appliances 70 having a polymeric shell with cavities shaped to receive and resiliently reposition teeth, including at least one appliance which is shaped to rotate a preselected tooth so that a crown of the tooth leans away from a desired location and at least another appliance shaped to apply a force to the at least one tooth to translate the at least one tooth toward the desired location such that the resulting mandibular position after optimized tooth movement is at least somewhat more comfortable than the mandibular position when the teeth were in the original occlusion.

In one embodiment, said bite registration may be recorded by taking a bite registration with a digital intraoral scanner 40 while a user wears at least a portion of said device. In an additional embodiment, said bite registration may be recorded by taking a bite registration using bite registration material 50 while a user wears at least a portion of said device. In an additional embodiment, said bite registration may be recorded by scanning the patient with a cone beam CT or similar imaging technology while a user occludes on at least a portion of said device 10.

A computer-implemented method may provided for repositioning the teeth and/or mandible of a user, comprising executing on a processor the steps of: receiving, on a computer, digital bite registration data indicating at least the mandibular and maxillary position of a user when wearing a polymeric shell 10 having an occlusal surface 30 that said occlusal surface confirms at least one optimization function; storing the digital bite registration data in the memory of the computer; using the stored digital bite registration data to generate a digital arrangement of the user's teeth; applying an optimization function to the digital arrangement of the user's teeth by specifying a sequence of tooth movements to move the teeth through a series of discrete tooth arrangements 60, wherein at least some of the tooth arrangements are represented by digital data sets, wherein specifying a sequence of tooth movements comprises moving teeth according to an optimization function; and transmitting the optimized production data set for fabrication of one or more appliances in accordance with the digital data sets wherein the appliances comprise polymeric shells 70 having cavities and wherein the cavities of successive shells have different geometries shaped to receive and resiliently reposition teeth from one tooth arrangement to a successive tooth arrangement. In one embodiment, said optimization function of said occlusal surface may be mandibular force equilibration.

An apparatus for producing appliances to treat symptoms of temporomandibular joint disorder may include a means for generating a digital arrangement of teeth; specifying a bite registration in a disoccluded occlusion to determine an optimization function; generating at least one mandibular repositioning appliance 10, confirming an desired optimization function when said mandibular repositioning appliance is worn by a user, specifying a digital or physical bite registration taken when a user is wearing at least a portion of said mandibular positioning appliance 10, and moving at least one tooth 60 utilizing a series of a polymeric shells 70 with cavities shaped to receive teeth capable of exerting force on at least one tooth to achieve an optimized movement such that the mandible is capable of being repositioned according to said optimization function reference. In one embodiment, said disoccluded centric occlusion may be recorded at a desired position by placing a bite stop at least one tooth and having the user attempt to close into centric occlusion until they feel contact on the stop. In another embodiment, said bite registration when a user is wearing at least a portion of said device may be recorded by taking a bite registration with a digital intraoral scanner 40 while a user wears at least a portion of said device. In an additional embodiment, said bite registration when a user is wearing at least a portion of said device may be recorded by taking a bite registration using bite registration material 50 while a user wears at least a portion of said device. In an additional embodiment, said bite registration when a user is wearing at least a portion of said device may be recorded by scanning the patient with a cone beam CT or similar imaging technology while a user occludes on at least a portion of said device.

A system for repositioning a teeth and/or mandibular position from an initial location to a desired location functions may include a first polymeric shell 10 having an occlusal surface 30 and plurality of cavities 20 shaped to receive a tooth arch of the user; wherein the occlusal surface is configured to at least improve equilibration of the mandibular position when worn for a period of time; taking a mandibular positional registration while wearing said first polymeric shell orthotic or at least some portion of it; a plurality of dental position adjustment appliances having a polymeric shell with cavities shaped to receive and resiliently reposition teeth, including at least one appliance, which may be shaped to rotate a preselected tooth so that a crown of the tooth leans away from a desired location and at least another appliance shaped to apply a force to the at least one tooth to translate the at least one tooth toward the desired location; and one or more attachment devices able to be positioned on at least one tooth for use in transmitting forces from the positioning adjustment appliances to the teeth.

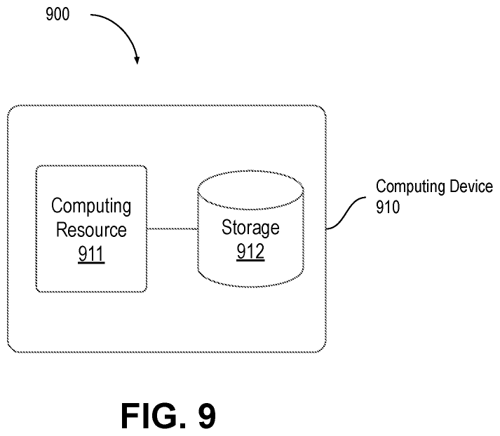

FIG. 9 Illustrates an operational environment 900 for one or more of the implementations herein. As illustrated in FIG. 9, environment 900 may include actors, including one or more computing device(s) 910.

Computing device(s) 910 may include any variety of devices configurable to perform the implementations and methods disclosed herein including, for example, a server, a desktop computer, a laptop computer, a handheld computer, a tablet computing platform, a Netbook, a Smartphone, a gaming console, and/or other computing platforms.

Computing device 910 may include computing resource 911. Computing resource 911 may include, for example, one or more processor(s) configured to execute machine-readable instructions for implementing all or some of the implementations herein. Computing resource 911 may be configured to access storage 912 to retrieve and/or write electronic data from and to storage 912.

Computing device 910 may include storage 912. Storage 912 may be configured to host one or more databases or other forms of data storage for use in implementations herein. Storage 912 may be accessible by computing resource 911.

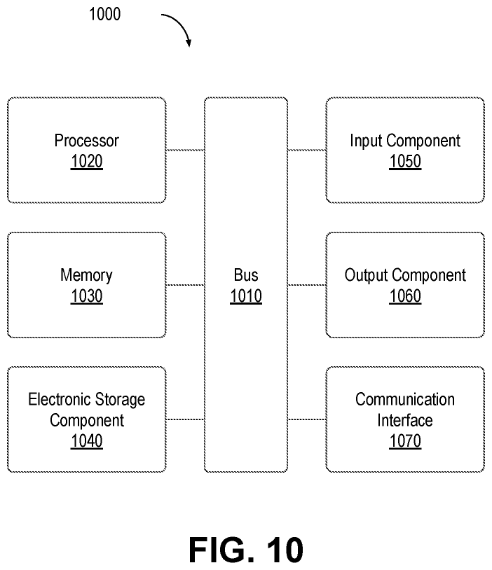

FIG. 10 is a diagram of example components of a device 1000, which may correspond to one or more of the device(s), network(s), resource(s), or service(s) of FIG. 2. In some implementations, one or more of the device(s), network(s), resource(s), or service(s) of FIG. 2 may include one or more devices 1000 and/or one or more components of device 1000, for example, according to a client/server architecture, a peer-to-peer architecture, and/or other architectures, which may include a plurality of hardware, software, and/or firmware components operating together to provide the functionality attributed herein to device 1000. In some implementations, device 1000 may include a distributed computing architecture (e.g., one or more individual computing platforms operating in concert to accomplish a computing task). For example, device 1000 may be implemented by a cloud of computing platforms operating together as device 1000. By way of non-limiting example, a given device 1000 may include one or more of a server, a desktop computer, a laptop computer, a handheld computer, a tablet computing platform, a Netbook, a Smartphone, a gaming console, and/or other computing platforms.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As shown in FIG. 10, device 1000 may include a bus 1010, a processor 1020, a memory 1030, a storage component 1040, an input component 1050, an output component 1060, and a communication component 1070.

Bus 1010 includes a component that enables wired and/or wireless communication among the components of device 1000.

Processor 1020 includes a central processing unit, a graphics processing unit, a microprocessor, a controller, a microcontroller, a digital signal processor, a field-programmable gate array, an application-specific integrated circuit, and/or another type of processing component. Processor 1020 is implemented in hardware, firmware, or a combination of hardware and software. In some implementations, processor 1020 includes one or more processors capable of being programmed to perform a function. Such processors may or may not be all integral to the same physical device, and may in some embodiments be distributed among several devices.

Processor 1020 may be configured to execute one or more of the modules disclosed herein, and/or other modules by software; hardware; firmware; some combination of software, hardware, and/or firmware; and/or other mechanisms for configuring processing capabilities on processor 1020. As used herein, the term “module” may refer to any component or set of components that perform the functionality attributed to the module. This may include one or more physical processors during execution of processor readable instructions, the processor readable instructions, circuitry, hardware, storage media, or any other components. Various modules or portions thereof may be implemented in any of various ways, including procedure-based techniques, component-based techniques, and/or object-oriented techniques, among others. For example, the program instructions may be implemented using system libraries, language libraries, model-view-controller (MVC) principles, application programming interfaces (APIs), system-specific programming languages and principles, cross-platform programming languages and principles, pre-compiled programming languages, markup programming languages, stylesheet languages, “bytecode” programming languages, object-oriented programming principles or languages, other programming principles or languages, C, C++, C#, Java, JavaScript, Python, PHP, HTML, CSS, TypeScript, R, Elm, Unity, VB.Net, Visual Basic, Swift, Objective-C, Perl, Ruby, Go, SQL, Haskell, Scala, Arduino, assembly language, Microsoft Foundation Classes (MFC), Streaming SIMD Extension (SSE), or other technologies or methodologies, as desired.

It should be appreciated that although some modules disclosed herein may be illustrated for example as being implemented within a single processing unit, in embodiments in which processor 1020 includes multiple processing units, one or more of modules disclosed herein may be implemented remotely from the other modules. The description of the functionality provided by the different modules disclosed herein is for illustrative purposes, and is not intended to be limiting, as any of modules described herein may provide more or less functionality than is described. For example, one or more of modules disclosed herein may be eliminated, and some or all of its functionality may be provided by other ones of modules disclosed herein. As another example, processor 1020 may be configured to execute one or more additional modules that may perform some or all of the functionality attributed herein to one of modules disclosed herein.

Memory 1030 includes a random-access memory, a read only memory, and/or another type of memory (e.g., a flash memory, a magnetic memory, and/or an optical memory).

Electronic storage component 1040 stores information and/or software related to the operation of device 1000. For example, electronic storage component 1040 may include a hard disk drive, a magnetic disk drive, an optical disk drive, a solid-state disk drive, a compact disc, a digital versatile disc, and/or another type of non-transitory computer-readable medium. Implementations of electronic storage component 1040 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Implementations of electronic storage component 1040 may include one or both of system storage provided integrally (i.e., substantially non-removable) to device 1000 and/or removable storage that is removably connectable to device 1000 via, for example, a port (e.g., a USB port, an IEEE 1394 port, a THUNDERBOLT™ port, etc.) or a drive (e.g., disk drive, flash drive, or solid-state drive etc.). Electronic storage component 1040 may also or alternatively include one or more virtual storage resources (e.g., cloud storage, a virtual private network, and/or other virtual storage resources). An electronic storage may store software algorithms, information determined by one or more processors, information received from one or more computing platforms, information received from one or more remote platforms, databases (e.g., structured query language (SQL) databases (e.g., MYSQL®, MARIADB®, MONGODB®), NO-SQL databases, among others), and/or other information enabling a computing platform to function as described herein.

Input component 1050 enables device 1000 to receive input, such as user input and/or sensed inputs. For example, input component 1050 may include a touch screen, a keyboard, a keypad, a mouse, a button, a microphone, a switch, a sensor, a global positioning system component, an accelerometer, a gyroscope, and/or an actuator.

Output component 1060 enables device 1000 to provide output, such as via a display, a speaker, and/or one or more light-emitting diodes.

Communication component 1070 enables device 1000 to communicate with other devices, such as via a wired connection and/or a wireless connection, for example, via the internet and/or other networks using, for example, TCP/IP or cellular hardware enabling wired or wireless (e.g., cellular, 2G, 3G, 4G, 4G LTE, 5G, or WiFi) communication. For example, communication component 1070 may include a receiver, a transmitter, a transceiver, a modem, a network interface card, and/or an antenna.

Device 1000 may perform one or more processes described herein. For example, a non-transitory computer-readable medium (e.g., memory 1030 and/or storage component 1040) may store a set of instructions (e.g., one or more instructions, code, software code, and/or program code) for execution by processor 1020. Processor 1020 may execute the set of instructions to perform one or more processes described herein. In some implementations, execution of the set of instructions, by one or more processors 1020, causes the one or more processors 1020 and/or the device 1000 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 10 are provided as an example. Device 1000 may include additional components, fewer components, different components, or differently arranged components than those shown in FIG. 10. Additionally, or alternatively, a set of components (e.g., one or more components) of device 1000 may perform one or more functions described as being performed by another set of components of device 1000.

In addition to the example configuration described herein in FIG. 10, various steps, functions, and/or operations of device 1000 and the methods disclosed herein may be carried out by one or more of, for example, electronic circuits, logic gates, multiplexers, programmable logic devices, ASICs, analog or digital controls/switches, microcontrollers, or computing systems. Program instructions implementing methods such as those described herein may be transmitted over or stored on carrier medium. The carrier medium may include a storage medium such as a read-only memory, a random-access memory, a magnetic or optical disk, a non-volatile memory, a solid-state memory, a magnetic tape, and the like. A carrier medium may include a transmission medium such as a wire, cable, or wireless transmission link.

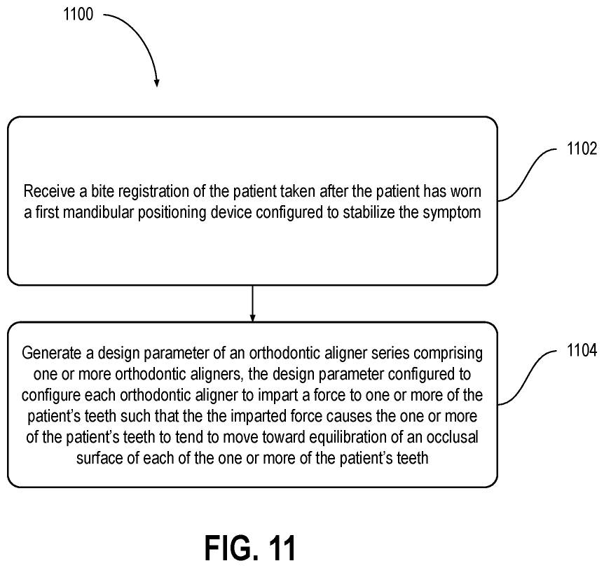

FIG. 11 is a flowchart illustrating an example method 1100 for orthodontic treatment, according to one or more implementations herein. In some implementations, one or more operations illustrated in FIG. 11 may be performed by one or more devices of FIG. 9. Additionally, or alternatively, one or more operations illustrated in FIG. 11 may be performed by one or more components of device 1000.

An operation 1102 may include receiving a bite registration of the patient taken after the patient has worn a first mandibular positioning device configured to stabilize the symptom, and may be performed alone or in combination with one or more other operations depicted in FIG. 11. The bite registration may be taken while the patient is wearing the first mandibular positioning device or after (e.g., after removing the first mandibular positioning device).

An operation 1104 may include generating a design parameter of an orthodontic aligner series comprising one or more orthodontic aligners, each comprising a polymeric shell, the design parameter configured to configure each orthodontic aligner to impart a force to one or more of the patient's teeth such that the the imparted force causes the one or more of the patient's teeth to tend to move toward equilibration of an occlusal surface of each of the one or more of the patient's teeth, and may be performed alone or in combination with one or more other operations depicted in FIG. 11. The move toward equilibration of the occlusal surface of the tooth may include one or more of a rotation, translation, extrusion or intrusion of the tooth. The bite registration may be taken using, inter alia, a digital intraoral scanner, a bite registration material, or a cone beam computed tomography scanner.

The method may further comprise producing one or more of the orthodontic aligners of the orthodontic aligner series.

The polymeric shell and/or the second polymeric shell may be configured to mount directly to the teeth of the patient.

The polymeric shell and/or the second polymeric shell may be configured to mount to the patient using an attachment device.

The polymeric shell and/or the second polymeric shell may comprise a clear resin.

Although FIG. 11 depicts an example method 1100 and operations thereof, in some implementations, a method illustrated herein may include additional operations, fewer operations, differently arranged operations, or different operations than the operations depicted in FIG. 11. Moreover, or in the alternative, two or more of the operations depicted in FIG. 11 may be performed at least partially in parallel.

Various characteristics, advantages, implementations, embodiments, and/or examples relating to the invention have been described in the foregoing description with reference to the accompanying drawings. However, the above description and drawings are illustrative only. The invention is not limited to the illustrated implementations, embodiments, and/or examples, and all implementations, embodiments, and/or examples of the invention need not necessarily achieve every advantage or purpose, or possess every characteristic, identified herein. Accordingly, various changes, modifications, or omissions may be effected by one skilled in the art without departing from the scope or spirit of the invention, which is limited only by the appended claims. Although example materials and dimensions have been provided, the invention is not limited to such materials or dimensions unless specifically required by the language of a claim. Elements and uses of the above-described implementations, embodiments, and/or examples can be rearranged and combined in manners other than specifically described above, with any and all permutations within the scope of the invention, as limited only by the appended claims.

In the claims, various portions may be prefaced with letter or number references for convenience. However, use of such references does not imply a temporal or ordered relationship not otherwise required by the language of the claims. Unless the phrase ‘means for’ or ‘step for’ appears in a particular claim or claim limitation, such claim or claim limitation should not be interpreted to invoke 35 U.S.C. § 112(f).

As used herein, satisfying a threshold may, depending on the context, refer to a value being greater than the threshold, greater than or equal to the threshold, less than the threshold, less than or equal to the threshold, equal to the threshold, and/or the like, depending on the context.

As used in the specification and in the claims, use of “and” to join elements in a list forms a group of all elements of the list. For example, a list described as comprising A, B, and C defines a list that includes A, includes B, and includes C. As used in the specification and in the claims, use of “or” to join elements in a list forms a group of at least one element of the list. For example, a list described as comprising A, B, or C defines a list that may include A, may include B, may include C, may include any subset of A, B, and C, or may include A, B, and C. Unless otherwise stated, lists herein are inclusive, that is, lists are not limited to the stated elements and may be combined with other elements not specifically stated in a list. As used in the specification and in the claims, the singular form of ‘a’, ‘an’, and ‘the’ include plural referents (e.g., one or more of the referent) unless the context clearly dictates otherwise.

It is to be expressly understood that the drawings are for the purpose of illustration and description only and are not intended as a definition of the limits of the invention.

It is to be expressly understood that the drawings are for the purpose of illustration and description only and are not intended as a definition of the limits of the invention.

Unless otherwise stated, any range of values disclosed herein sets out a lower limit value and an upper limit value, and such ranges include all values and ranges between and including the limit values of the stated range, and all values and ranges substantially within the stated range as defined by the order of magnitude of the stated range.

The inventors hereby state their intent to rely on the Doctrine of Equivalents to determine and assess the reasonably fair scope of their invention as pertains to any apparatus not materially departing from but outside the literal scope of the invention as set out in the following claims.

I claim:

1. A method for repositioning one or more teeth of a patient presenting with a symptom of temporomandibular joint disorder, comprising:
receiving, at a processor, a bite registration of the patient taken after the patient has worn a first mandibular positioning device configured to stabilize the symptom; and
generating, using the processor, a design parameter of an orthodontic aligner series comprising one or more orthodontic aligners, each comprising a polymeric shell, the design parameter configured to configure each orthodontic aligner to impart a force to one or more of the patient's teeth such that the the imparted force causes the one or more of the patient's teeth to tend to move toward equilibration of an occlusal surface of each of the one or more of the patient's teeth.

2. The method of claim 1, wherein the bite registration of the patient is taken while the patient is wearing the first mandibular position device.

3. The method of claim 1, further comprising producing at least one of the one or more orthodontic aligners.

4. The method of claim 1, wherein the move toward equilibration of the occlusal surface includes a rotation of one or more of the patient's teeth.

5. The method of claim 1, wherein the move toward equilibration of the occlusal surface includes a translation of one or more of the patient's teeth.

6. The method of claim 1, wherein the move toward equilibration of the occlusal surface includes an extrusion of one or more of the patient's teeth.

7. The method of claim 1, wherein the move toward equilibration of the occlusal surface includes an intrusion of one or more of the patient's teeth.

8. The method of claim 1, wherein the bite registration is taken using a digital intraoral scanner.

9. The method of claim 1, wherein the bite registration is taken using a bite registration material.

10. The method of claim 1, wherein the bite registration is taken using a cone beam computed tomography scanner.

11. The method of claim 1, wherein each polymeric shell is configured to mount directly to teeth of the patient.

12. The method of claim 1, wherein each polymeric shell is configured to mount to the patient using an attachment device.

13. The method of claim 1, wherein each polymeric shell comprises a clear resin.

14. A system for repositioning one or more teeth of a patient presenting with a symptom of temporomandibular joint disorder, comprising a processor configured to perform a method comprising:
receiving, at the processor, a bite registration of the patient taken after the patient has worn a first mandibular positioning device configured to stabilize the symptom; and
generating, using the processor, a design parameter of an orthodontic aligner series comprising one or more orthodontic aligners, each comprising a polymeric shell, the design parameter configured to configure each orthodontic aligner to impart a force to one or more of the patient's teeth such that the the imparted force causes the one or more of the patient's teeth to tend to move toward equilibration of an occlusal surface of each of the one or more of the patient's teeth.

15. The system of claim 14, wherein the bite registration is taken using a digital intraoral scanner.

16. The system of claim 14, wherein the bite registration is taken using a bite registration material.

17. The system of claim 14, wherein the bite registration is taken using a cone beam computed tomography scanner.

18. The system of claim 14, wherein the bite registration of the patient is taken while the patient is wearing the first mandibular position device.

19. A tangible, non-transient, computer-readable media having instructions thereupon which when implemented by a processor cause the processor to perform a method for repositioning one or more teeth of a patient presenting with a symptom of temporomandibular joint disorder, comprising:
receiving a bite registration of the patient taken after the patient has worn a first mandibular positioning device configured to stabilize the symptom; and
generating a design parameter of an orthodontic aligner series comprising one or more orthodontic aligners, each comprising a polymeric shell, the design parameter configured to configure each orthodontic aligner to impart a force to one or more of the patient's teeth such that the the imparted force causes the one or more of the patient's teeth to tend to move toward equilibration of an occlusal surface of each of the one or more of the patient's teeth.

20. The tangible, non-transient, computer-readable media of claim 19, wherein the bite registration of the patient is performed while the patient is wearing the first mandibular position device.
